(19) United States
(12) Patent Application Publication
(10) Pub. No.: US 2015/0248145 A1
(43) Pub. Date: Sep. 3, 2015

(54) ELECTRONIC APPARATUS AND METHOD FOR CHECKING ATTACHED STATE OF COVER

(71) Applicant: Samsung Electronics Co., Ltd., Gyeonggi-do (KR)

(72) Inventor: Do Hyung Lee, Gyeonggi-do (KR)

(21) Appl. No.: 14/562,023

(22) Filed: Dec. 5, 2014

(30) Foreign Application Priority Data
Feb. 28, 2014 (KR) 10-2014-0024486

(51) Int. Cl. G06F 1/16

(52) U.S. Cl. CPC G06F 1/1675

(57) ABSTRACT

Provided is an electronic apparatus including a detachable cover, a sensing unit configured to sense a state of the cover, an analysis unit configured to analyze values sensed from the sensing unit to determine an attached state of the cover, and a display configured to display an object indicating a position of an unattached portion when at least a portion of the cover is not attached.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Feb. 28, 2014 and assigned Serial No. 10-2014-0024486, the entire disclosure of which is hereby incorporated by reference.

### TECHNICAL FIELD

The present invention relates to an electronic apparatus with a detachable cover and a method for checking an attached state of a cover.

### BACKGROUND

Various electronic apparatuses have been developed and released thanks to the advances in electronic technology. In particular, a demand for a portable electronic apparatus such as a mobile phone, a tablet PC, and a Notebook PC has been increasing recently. The rapid growth in use of an electronic apparatus increases the customer needs for diverse functions. As a result, manufacturing companies have developed products with new functions to meet the customer needs. For instance, a recently released mobile phone has a self waterproof or a dustproof function.

Portable electronic apparatuses typically use batteries as a power source due to their own characteristics. Portable electronic apparatuses can be manufactured in the form of battery embedded type or battery detachable type. Portable electronic apparatuses that use detachable batteries have a protection cover for installed batteries.

To provide a waterproof function for a portable electric apparatus having a detachable battery, the electronic apparatus has to operate in a state that a battery cover or various input/output ports thereof are completely sealed. When the battery cover or any of the ports is not completely sealed due to a user's mistake, the portable electronic apparatus can be seriously damaged due to water.

### SUMMARY

To address the above-discussed deficiencies, it is a primary object to provide an electronic device and a method for checking an attached state of a cover in which the attached state of the cover or the like for a waterproof function may be notified to a user to avoid damage by a users' mistake.

In a first example, an electronic apparatus includes a detachable cover. The electronic apparatus also includes a sensing unit configured to sense a state of the cover. The electronic apparatus further includes an analysis unit configured to analyze values sensed by the sensing unit to determine an attached state of the cover at each position. The electronic apparatus includes a display configured to display an object that represents a position of an unattached portion when at least a portion of the cover is not attached.

In a second example, a method for sensing an attached state of a cover of an electronic apparatus is disclosed. The method includes sensing a state of a cover that is able to be detached from an electronic apparatus. The method also includes analyzing sensing values to determine the attached state of the cover at each position. The method further includes displaying an object representing a position of an unattached portion when at least a portion of the cover is not attached.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an example electronic apparatus configuration according to this disclosure.

FIGS. 2A through 2C are diagrams illustrating example cover structures according to this disclosure;

FIG. 3 is a diagram illustrating an example pressure sensor structure according to this disclosure;

FIGS. 4A through 4C are diagrams illustrating example display screens according to this disclosure; and

FIG. 5 is a flowchart illustrating an example method for checking an attached state of the cover of an electronic apparatus according to this disclosure.

### DETAILED DESCRIPTION

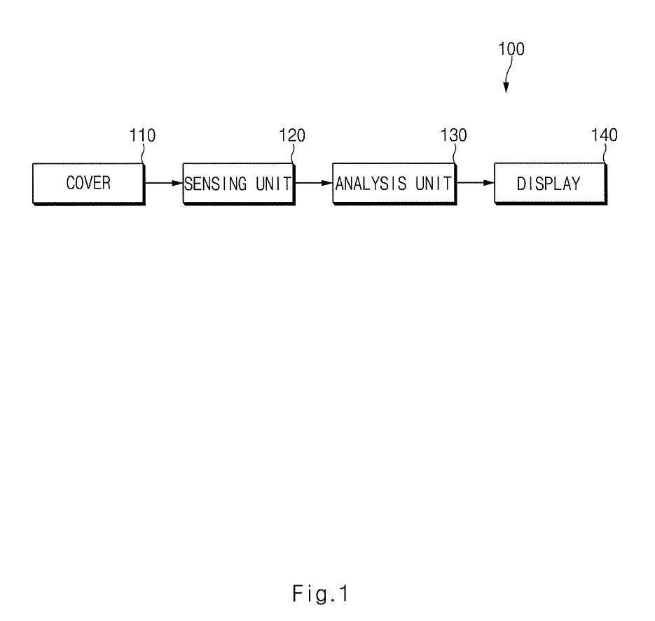

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic apparatus. Hereinafter, various embodiments of the present disclosure will be described in detail with reference to the accompanying drawings. Various changes may be applied in various embodiments of the present disclosure, and thus specific embodiments are illustrated in the drawings and described in detail. However, it should be understood that the specific embodiments below are not intended to limit various embodiments of the present disclosure, but rather the present disclosure is meant to cover all modifications and/or equivalents, and alternatives that are included in the spirit and scope of various embodiments of the present disclosure. With regard to figures, like reference numerals refer to like elements.

The term “include”, “comprise”, and “have”, or “may include” or “may comprise” and “may have” used herein indicates disclosed functions, operations, or existence of elements but does not exclude other functions, operations or elements. It will be further understood that the terms “comprise”, “include” and “have”, when used herein, are intended to specify the presence of features, integers, steps, operations, elements, components, and/or combinations thereof described in the specification, and/or components, but are not intended to exclude the presence or addition of one or more other features, integers, steps, operations, elements, components, and/or combinations thereof.

The meaning of the term “or” used herein includes any or all combinations of the words connected by the term “or”. For instance, the expression “A or B” can include A, B, or both A and B.

The terms such as “1^{st}”, “2^{nd}”, “first”, “second”, and the like used herein can modify different elements of various embodiments, but do not limit the elements. For instance, such terms do not limit the order and/or priority of the elements. Furthermore, such terms can be used to distinguish one element from another element. For instance, both “first user equipment” and “second user equipment” indicate user equipment but differ from each other. For instance, without departing from the scope of various embodiments of the present disclosure, a first element can be named as a second element, and similarly, a second element can be named as a first element.

It will be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

The terminology used herein is not for delimiting various embodiments of the present disclosure but for only describing specific embodiments. The terms of a singular form can include plural forms unless otherwise specified.

Unless otherwise defined, the terms used herein, including technical or scientific terms, have the same meanings as generally understood by those skilled in the art.

It will be further understood that turns, which are defined in the dictionary and commonly used, should also be interpreted as is customary in the related art and not in an idealized or overly formal sense unless expressly defined in various embodiments of the present disclosure.

An electronic apparatus according to various embodiments of the present disclosure has a communication function. For instance, electronic apparatus can include at least one of: smartphones, tablet personal computers (PCs), mobile phones, video phones, electronic book (e-book) readers, desktop PCs, laptop PCs, netbook computers, personal digital assistants (PDAs), portable multimedia player (PMPs), MP3 players, mobile medical devices, cameras, and wearable devices (such as head-mounted-devices (HMDs) such as electronic glasses, electronic apparel, electronic bracelets, electronic necklaces, electronic accessories, electronic tattoos, and smart watches).

According to some embodiments, an electronic apparatus is a smart home appliance having a communication function. For example, the smart home appliance can be at least one of: a television, a digital video disk (DVD) player, audio device, a refrigerator, an air conditioner, a cleaner, an oven, a microwave oven, a washing machine, an air cleaner, a set-top box, a TV box (such as SAMSUNG HOMSESYNC, APPLETV or GOOGLETV), a game console, an electronic dictionary, an electronic key, a camcorder, and an electronic picture frame.

According to some embodiments, an electronic apparatus includes at least one of: a medical device (such as a magnetic resonance angiography (MRA), a magnetic resonance imaging (MRI), a computed tomography (CT), a medical camera, and an ultrasonic device), a navigation device, global positioning system (GPS) receiver, an event data recorder (EDR), a flight data recorder (FDR), a vehicle infotainment device, an electronic equipment for a vessel (such as navigation systems and gyrocompasses), avionics equipment, a security device, a head unit for vehicles, industrial or home robots device, an automatic teller's machine (ATM) for a financial institution, and a points of sale (POS) system for a store.

According to some embodiments, an electronic apparatus includes at least one of: parts of furniture or buildings/structure having communication functions, electronic boards, electronic signature receiving devices, projectors, and measuring instruments (such as water meters, electricity meters, gas meters, and wave measuring apparatuses). An electronic apparatus according to various embodiments of the present disclosure includes one or more combinations of the above-mentioned apparatuses. Furthermore, an electronic apparatus according to various embodiments of the present disclosure is a flexible apparatus. In addition, the electronic apparatuses according to various embodiments of the present disclosure are not limited to the above-mentioned apparatuses.

Hereinafter, an electronic apparatus according to various embodiments will be described with reference to the accompanying drawings. The term “user” used herein can refer to a person who uses an electronic apparatus or can refer to an apparatus (such as an artificial intelligence electronic apparatus) that uses an electronic apparatus.

FIG. 1 is a block diagram illustrating an example electronic apparatus configuration according this disclosure.

Referring to FIG. 1, an electronic apparatus 100 includes a cover 110, a sensing unit 120, an analysis unit 130, and a display 140.

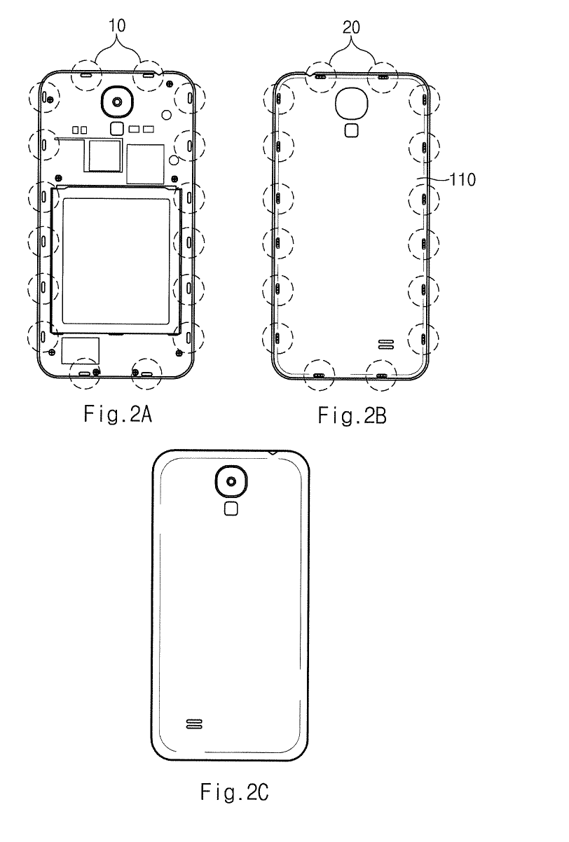

The cover 110 can be attached to a main body of the electronic apparatus 100. In certain embodiments, the cover is attached to the main body in a detachable manner. For example, the cover 110 can be attached to a rear side of the electronic apparatus. The structure of the cover 110 will be explained in detail with reference to FIGS. 2A-2C.

FIGS. 2A through 2C are diagrams illustrating the structure of example covers according to this disclosure.

FIG. 2A illustrates a main body of the electronic apparatus 100 in which the cover is not attached. FIG. 2A illustrates a rear side of the main body of the electronic apparatus 100. In the examples shown in FIGS. 2A-2C, the cover 110 can be attached to the rear side of the electronic apparatus 100. According to an embodiment, the main body of the electronic apparatus 100 has at least one groove for assembling the main body and the cover.

FIG. 2B is a diagram illustrating an example cover 110 according to this disclosure. The cover 110 can be attached to the rear side of the electronic apparatus 100 illustrated in FIG. 2A. According to an embodiment, the cover 100 includes at least one projection 20 for coupling the cover 110 to the main body of the electronic device 100. At least one projection 20 included in the cover 110 can be coupled with a corresponding groove 10 in the main body of the electronic apparatus 100.

FIG. 2C is a diagram illustrating a state in which the cover 110 is attached to the main body of the electronic apparatus 100 according to this disclosure.

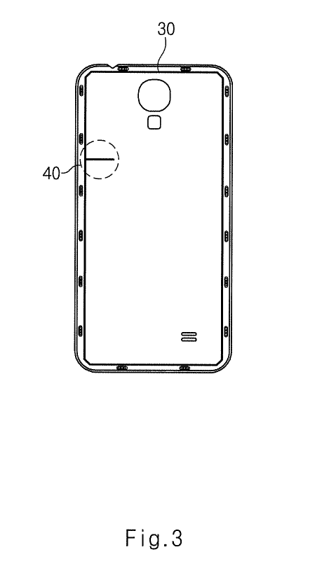

The sensing unit 120 senses a state of the cover 110. According to an embodiment, the sensing unit 120 includes a pressure sensor that is attached to the cover 110 and senses resistance values. The pressure sensor can sense resistance values that vary with a pressure applied to the cover 110. The structure of the pressure sensor will be explained with reference to FIG. 3.

FIG. 3 is a diagram illustrating an example structure of a pressure sensor 30 according to this disclosure.

Referring to FIG. 3, the pressure sensor 30 is attached to the cover 110. According to an embodiment, the pressure sensor 30 is attached to one of multiple sides of the cover 110 that faces the main body of the electronic apparatus 100. According to an embodiment, the pressure sensor 30 is attached to a side of the cover in the form of a looped curve. According to an embodiment, the pressure sensor 30 is attached to the edge of the cover or at a location position disposed at a predetermined distance from the edge to the center of the cover.

Referring to FIG. 3, the sensing unit 120 includes a power supply line 40 that supplies electricity to the pressure sensor 30. The power supply line 40 electrically connects the main body of the electric apparatus 100 with the pressure sensor 40 to supply electricity to the pressure sensor 40 when the cover 110 is attached to the main body of the electric apparatus 100.

The power sensor 30 senses a predetermined resistance value at each position in a state in which the cover 110 is properly attached to the main body of the electric apparatus 100. When a portion of the cover 100 is not fully attached to the main body of the electronic apparatus 100, the cover 110 may be bended partially. Bending of the cover 110 causes a pressure on bended part. As a result, a resistance value of the bended part is changed.

According to an embodiment, the sensing unit 120 includes an illumination sensor that senses an illumination value of a space between the cover 110 and the main body at each position. According to an embodiment, the illumination sensor is embedded in the electric apparatus 100. According to an embodiment, the sensing unit 120 includes at least one illumination sensor. When the sensing unit 120 includes a plurality of illumination sensors, the plurality of illumination sensors can be embedded in the electronic device 100 at different positions.

The sensed illumination values can be low when the cover 110 is attached to the main body of electronic apparatus 100 properly because incoming light is blocked. The light can enter when a portion of the cover 110 is not attached to the main body of electronic apparatus 100 properly. As a result, the illumination value of a position where the cover 110 is not attached properly can be relatively high.

According to an embodiment, the sensing unit 120 includes a microphone for sensing an assembly sound of the cover 110. According to an embodiment, the microphone is embedded in the electric apparatus 100. According to an embodiment, the sensing unit 120 includes at least one microphone. When the sensing unit 120 has a plurality of microphones, the plurality of microphones can be embedded in the electric apparatus 100 at different positions.

According to an embodiment, the sensing unit 120 includes an infrared sensor that senses the distance from the main body by each position. According to an embodiment, the infrared sensor is embedded in the electric apparatus 100. According to an embodiment, the sensing unit 120 can include at least one infrared sensor. When the sensing unit 120 has a plurality of infrared sensors, the plurality of infrared sensors can be embedded in the electric apparatus 100 at different positions.

The distance between the cover 110 and the main body of the electric apparatus 100 can be a predetermined value when the cover 110 is attached to the main body of the electric apparatus properly. The distance between the cover 110 and the main body can be larger when a portion of the cover 110 is not fully attached to the main body of electronic apparatus 100.

According to an embodiment, the sensing unit 120 includes at least one of following: a pressure sensor, an illumination sensor, a microphone, and an infrared sensor. For example, the sensing unit 120 can be configured with a pressure sensor and a microphone. For another example, the sensing unit 120 can be configured with a pressure sensor and an infrared sensor.

The analysis unit 130 can determine an attached state of the cover by analyzing the sensing value from the sensing unit 120. According to an embodiment, the analyzing unit 130 can determine the attached state of the cover at each position.

According to an embodiment, the analysis unit 130 determines the attached state of the cover through sensed resistance values when the sensing unit 120 includes the pressure sensor. For instance, the analysis unit 130 can determine that the cover 110 is not attached properly at a specific position when the resistance value sensed from the specific position is changed because the projection at the specific position of the cover 110 is not coupled to the corresponding groove.

According to an embodiment, the analysis unit 130 determines the attached state of the cover using the sensed illumination values when the sensing unit 120 includes the illumination sensor. For instance, the analysis unit 130 can determine that the cover 110 is not attached properly at a specific position when the illumination value sensed from the specific position is changed because the projection at the specific position is not coupled to the corresponding groove.

According to an embodiment, the analysis unit 130 determines the attached state of the cover using an assembly sound when the sensing unit 120 includes a microphone. For instance, the analysis unit 130 can determine that the cover 110 is attached completely when the number of assembly sounds is equal to the number of grooves or projections. For another example, the analysis unit 130 can determine that the cover 110 is not attached properly when the number of sensed assembly sounds is smaller than the number of grooves or projections.

According to an embodiment, when the sensing unit 120 includes a plurality of microphones, the analysis unit 130 determines an assembly position using a volume of the assembly sound sensed from the plurality of microphones. The analysis unit 130 can determine that relevant parts are not attached properly when the assembly sound at a specific position is not sensed.

According to an embodiment, the assembly sounds are different because the grooves or projections are made of different materials or in different shapes. The analysis unit 130 can determine the assembly positions by analyzing the characteristics such as frequency and waveform of the assembly sounds sensed from the microphones. The analysis unit 130 can determine that the relevant parts are not attached properly when the assembly sound at a specific position is not sensed.

According to an embodiment, the analysis unit 130 determines the attached state of the cover using the sensed distance values when the sensing unit 120 includes infrared sensors. For instance, the analysis unit 130 can determine that the cover 110 is not attached properly at a specific position when the distance value sensed at the specific position is changed because the projection of the cover 110 at the specific position is not coupled to the corresponding groove.

According to an embodiment, when the sensing unit 120 is provided with two or more kinds of sensors, the sensing unit 120 can determine the attached state of the cover 110 by use of multiple sensing values. The analysis unit 130 can determine the attached state of the cover 110 by using different sensing values. When the attached states sensed by the respective sensors are different, the analysis unit 130 can determine that the cover is property attached at only a specific position where all the sensors determine the attached state as a normal state. When the one of attached states sensed on the basis of the respective sensors is determined as a detached state, the analysis unit 130 can determine that the cover is not attached at the corresponding position.

The display 140 can display the attached state of the cover determined by the analysis unit 130. According to an embodiment, the display 140 displays an object that requests to check the attached state of the cover when at least a portion of the cover 110 is not attached. According to an embodiment, the display 140 displays an object that shows the detached position when a portion of the cover 110 is not attached. According to an embodiment, the display 140 displays an object that requests to attach an unattached portion when a, portion of the cover 110 is not attached. According to an embodiment, the display 140 displays an object showing that the cover is completely attached when the cover 110 is fully attached. According to an embodiment, the display 140 displays an object showing the waterproof or dustproof function is normally operated when the cover 110 is attached properly.

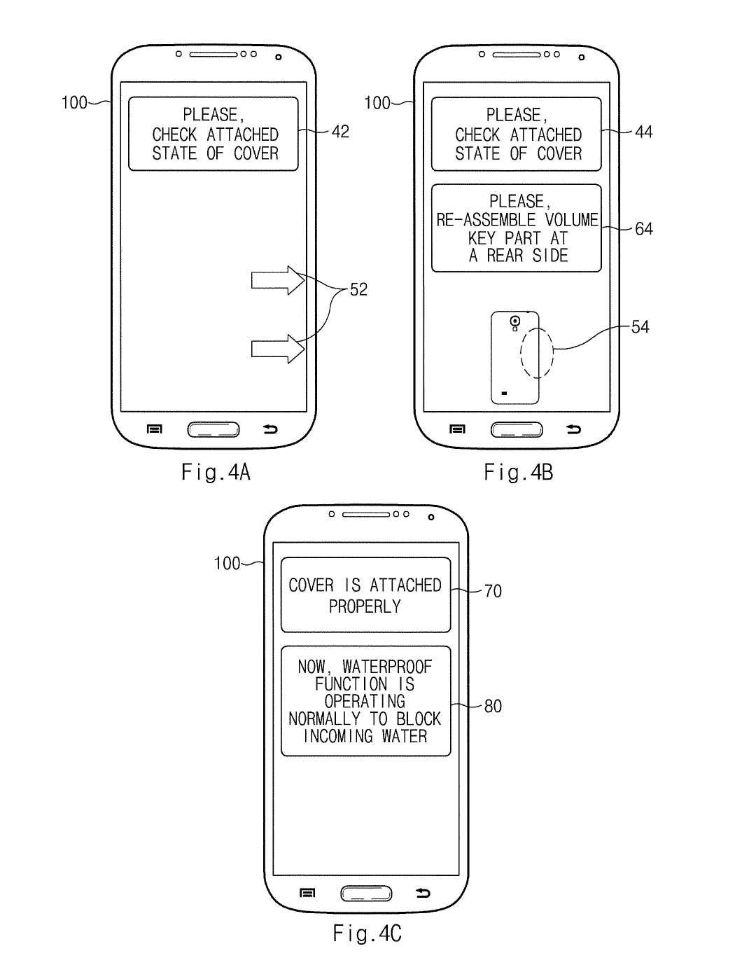

According to an embodiment, objects displayed on the display 140 includes various types of objects such as characters, figures, numbers, illustrations, icons, and colors. A display screen provided by the display 140 will be explained in detail with reference to FIGS. 4A through 4C.

FIGS. 4A through 4C are diagrams illustrating example display screens according to this disclosure.

Referring to FIG. 4A, the display 140 can display an 42 that requests to check the attached state of the cover when at least a portion of the cover 110 is not attached. For example, the display 140 can display a character object 42 representing “Please, check the attached state of the cover” as illustrated in FIG. 4A.

Referring to FIG. 4A, the display 140 can display an object representing an unattached portion when at least a portion of the cover 110 is not attached. For example, the display 140 can display a figure object such as arrows 52 indicating the unattached portion as illustrated in FIG. 4A.

Referring to FIG. 4B, the display 140 can display an object 44 that requests to check the attached state of the cover when at least a portion of the cover 110 is not attached. For example, the display 140 can display a character object 44 representing “Please, check the attached state of the cover” as illustrated in FIG. 4B.

Referring to FIG. 4B, the display 140 can display an object 64 that requests to attach an unattached portion when at least a portion of the cover 110 is not attached. For example, the display 140 can display a character object 64 representing “Please, re-assemble a volume key part at a rear side” as illustrated in FIG. 4B.

Referring to FIG. 4B, the display 140 can display an object 54 indicating an unattached portion when at least a portion of the cover 110 is not attached. For example, the display 140 can display an illustration object 54 indicating the unattached portion as illustrated in FIG. 4B.

Referring to FIG. 4C, the display 140 can display an object 70 representing the cover is completely attached when the cover 110 is fully attached. For example, the display 140 can display a character object 70 representing “The cover is attached properly” as illustrated in FIG. 4C.

Referring to FIG. 4C, the display 140 can display an object 80 representing that the waterproof function is under normal operating condition when the cover is attached completely. For example, the display 140 can display a character object 80 representing “The waterproof function is operating normally to block incoming water” as in FIG. 4C.

An electronic apparatus according to embodiments of the present disclosure can include a detachable cover, a sensing unit for sensing a state of the cover, an analysis unit that analyses sensing values of the sensing unit to determine the attached state of the cover, and a display that displays an object showing an unattached portion when at least a portion of the cover above is not attached properly.

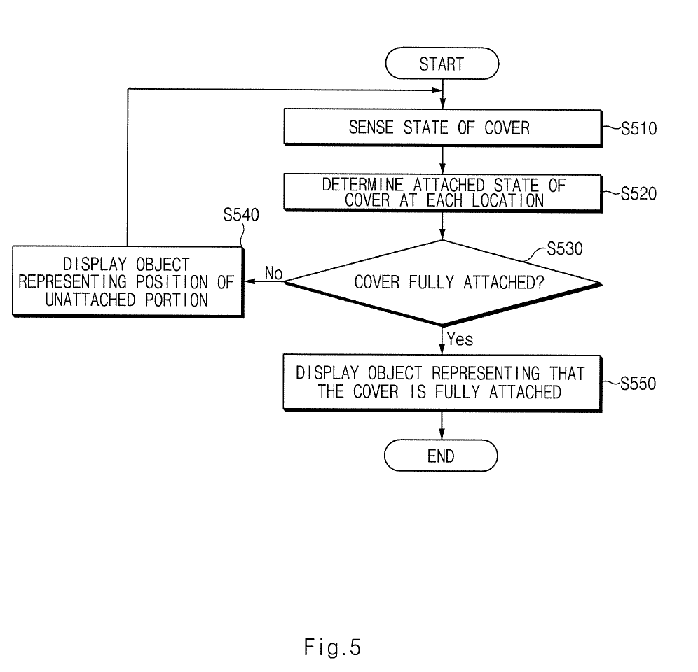

FIG. 5 is a flowchart illustrating an example method for checking an attached state of a cover according to this disclosure.

The flowchart in FIG. 5 can consist of time sequential processes which are performed in the electronic apparatus illustrated in FIG. 1. Therefore, description made on the electronic apparatus in FIG. 1 can also be applied to the flowchart in FIG. 5 even though the detailed description is omitted herein.

Referring to FIG. 5, the electronic apparatus 100 can sense the attached state of the cover. According to an embodiment, the electronic apparatus 100 can sense resistance values through the pressure sensor attached to the cover. The pressure sensor can sense the resistance value varying with a pressure applied to the cover 110. According to an embodiment, the electronic apparatus 100 can sense an illumination value at each position of a space between the cover and the main body using at least one illumination sensor. According to an embodiment, the electronic apparatus 100 can sense the assembly sound of the cover using at least one microphone. According to an embodiment, the electronic apparatus 100 can sense a distance from the main body at each position by using at least one infrared sensor.

According to an embodiment, the electronic apparatus 100 can sense a state of the cover by using two or more types of sensors. For instance, the electronic apparatus 100 can sense the state of the cover by using a pressure sensor and a microphone. For another instance, the electronic apparatus 100 can sense a state of the cover by using a pressure sensor and an infrared sensor (S510).

The electronic apparatus 100 can determine an attached state of the cover by using the sensing values sensed in operation S510 (S520). According to an embodiment, the electronic apparatus 100 can determine the attached state of the cover at each position. For instance, when the pressure sensor senses resistance values, the attached state of the cover can be determined by using the sensed resistance values. For another instance, when an illumination sensor senses resistance values, the attached state of the cover can be determined by using the sensed illumination values.

According to an embodiment, the electronic apparatus 100 can determine the attached state of the cover by using sensed values when the state of the cover is sensed by two or more types of sensors. For instance, the attached state of the cover can be determined by using different sensing values. According to an embodiment, when the attached states sensed by the respective sensors are different, the analysis unit 130 can determine that the cover is property attached at only a specific position where all the sensors determine the attached state as a normal state. When the one of attached states sensed on the basis of the respective sensors is determined as a detached state, the analysis unit 130 can determine that the cover is not attached at the corresponding position.

The electronic apparatus 100 can determine whether the cover is attached completely or not (S530). When the cover is not attached completely, the electronic apparatus 100 can display an object that shows a position of an unattached portion (S540). Thereafter, the electronic apparatus 100 can perform operations S510 to S530 again to determine whether the cover is attached completely or not.

According to an embodiment, the electronic device 100 can display an object that requests to check the attached state of the cover when at least a portion of the cover 110 is not attached. According to an embodiment, the electronic apparatus 100 can display an object that requests to attach an unattached portion when at least a portion of the cover is not attached.

When the cover is attached completely, the electronic apparatus (100) can display an object showing that the cover is attached completely (S550). According to an embodiment, the electronic apparatus can display an object showing the waterproof or dustproof function operates normally when the cover is attached properly.

According to an embodiment, the objects displayed by the electronic apparatus 100 can include various types of objects such as characters, figures, numbers, illustrations, icons, and colors.

The method for checking the attached state of the cover in the electronic apparatus according to an embodiment of the present disclosure can include sensing a state of the attachable cover, analyzing sensing values to determine the attached state of the cover at each position, and displaying a position of an unattached portion when at least a portion of the cover is not attached properly.

The method for checking the attached state of the cover according to various embodiments of the present disclosure can be implemented by programs executable in the electronic apparatus. Furthermore, these programs can be stored in various kinds of recording media and used.

Specifically, a program code for implementing the methods mentioned above can be stored in various kinds of non-volatile recording media such as a flash memory, a Read Only Memory (ROM), an Erasable Programmable ROM (EPROM( ) an Electronically Erasable and Programmable ROM (EEPROM), a hard disk, a removable disk, a memory card, a Universal Serial Bus (USB) memory, and a Compact Disc ROM (CD-ROM).

According to various embodiments of the present disclosure, the attached state of the cover is notified to users to avoid damages occurred by a user's mistake. Providing notice of an exact location where the cover is not properly attached can reduce a time for re-attaching the cover.

Although the present disclosure has been described with an exemplary embodiment, various changes and modifications can be suggested to one skilled in the art. It is intended that the present disclosure encompass such changes and modifications as fall within the scope of the appended claims.

What is claimed is:

1. An electronic apparatus, comprising:
a detachable cover;
a sensing unit configured to sense a state of the cover;
an analysis unit configured to analyze values sensed by the sensing unit to determine an attached state of the cover at each position; and
a display configured to display an object that represents a position of an unattached portion when at least a portion of the cover is not attached.

2. The electronic apparatus according to claim 1, wherein the sensing unit includes a pressure sensor configured to sense a resistance value of the cover at each position, and
the analysis unit is configured to determine the attached state of the cover using the resistance value.

3. The electronic apparatus according to claim 1, wherein the sensing unit includes an illumination sensor configured to sense an illumination value of a space between the cover and a main body at each position, and
the analysis unit is configured to determine the attached state of the cover using the illumination value.

4. The electronic apparatus according to claim 1, wherein the sensing unit includes a microphone configured to sense an assembly sound of the cover, and
the analysis unit is configured to determine the attached state of the cover using the assembly sound.

5. The electronic apparatus according to claim 1, wherein the sensing unit includes an infrared sensor configured to sense a distance between the main body and the cover at each position, and
the analysis unit is configured to determine the attached state of the cover using the sensed distance.

6. The electronic apparatus according to claim 1, wherein the sensing unit includes at least two of the following:
a pressure sensor configured to sense a resistance value of the cover at each position;
an illumination sensor configured to sense an illumination value of a space between the cover and a main body;
a microphone configured to sense an assembly sound of the cover; and
an infrared sensor configured to sense a distance between the main body and the cover at each position, and
wherein the analysis unit is configured to determine the attached state of the cover using a plurality of sensing values of the sensing unit.

7. The electronic apparatus according to claim 1, wherein the display is configured to display an object that requests to attach an unattached portion when at least a portion of the cover is not fully attached.

8. The electronic apparatus according to claim 1, wherein the display is configured to display an object representing that the cover is completely attached when the cover is fully attached.

9. A method for sensing an attached state of a cover of an electronic apparatus, the method comprising:
sensing a state of a cover that is able to be detached from an electronic apparatus;
analyzing sensing values to determine the attached state of the cover at each position; and
displaying an object representing a position of an unattached portion when at least a portion of the cover is not attached.

10. The method according to claim 9, wherein the sensing of the state of the cover includes sensing a resistance value of the cover at each position, and
determining the attached state of the cover includes determining the attached state of the cover using the resistance value.

11. The method according to claim 9, wherein the sensing of the state of the cover includes sensing an illumination value of a space between the cover and a main body at each position, and
determining the attached state of the cover includes determining the attached state of the cover using the illumination value sensed at each position.

12. The method according to claim 9, wherein the sensing of the state of the cover includes sensing an assembly sound of the cover, and
the determining the attached state of the cover includes determining the attached state of the cover using the assembly sound.

13. The method according to claim 9, wherein the sensing of the state of the cover includes sensing a distance between a main body and the cover at each position, and
the determining the attached state of the cover includes determining the attached state of the cover using the sensed distance.

14. The method according to claim 9, wherein the sensing of the state of the cover includes at least two of the following:
sensing a resistance value of the cover at each position;
sensing an illumination value of a space between the cover and the main body at each position;
sensing an assembly sound of the cover; and
sensing a distance between the main body and the cover at each position, and
determining of the attached state of the cover includes determining the attached state of the cover using a plurality of sensing values.

15. The method according to claim 9, wherein the displaying of the object includes displaying an object requesting to attach an unattached portion when at least a portion of the cover is not attached.

16. The method according to claim 9, wherein the displaying of the object includes displaying an object representing that the cover is completely attached when the cover is fully attached.
